(19) United States
(12) Patent Application Publication
(10) Pub. No.: US 2026/0318474 A1
(43) Pub. Date: Oct. 15, 2026

(54) Motorized Umbrella Stand Device

(71) Applicants: Julius Binetti, Jupiter, FL (US); Michael Binetti, Savannah, GA (US)

(72) Inventors: Julius Binetti, Jupiter, FL (US); Michael Binetti, Savannah, GA (US)

(21) Appl. No.: 19/278,263

(22) Filed: Jul. 23, 2025

Related U.S. Application Data
(60) Provisional application No. 63/787,049, filed on Apr. 11, 2025.

(51) Int. Cl. F16M 11/42; B60L 8/00; B60L 15/40; B60L 53/16; E04H 12/22; H02S 20/30

(52) U.S. Cl. CPC F16M 11/42; B60L 8/003; B60L 15/40; B60L 53/16; E04H 12/2238; H02S 20/30

(57) ABSTRACT

A motorized umbrella stand device is provided having a body configured to be positioned beneath and that receives a variety of outdoor umbrella stands. The body further comprises multiple wheels for mobility, each of which may include a locking mechanism to prevent unintentional movement. Wheel actuation is enabled through one or more integrated motors powered by a rechargeable battery system, which may be recharged via a charging port or an optional solar panel mounted on an articulation mount. The motor is wirelessly controlled via a remote control and/or a mobile application that includes directional control, braking engagement, and location programming functionality. A GPS module integrated within the device allows for autonomous repositioning based on user-defined locations or solar tracking algorithms.

### CROSS REFERENCE TO RELATED APPLICATION

The present application claims priority to, and the benefit of, U.S. Provisional Application No. 63/787,049, which was filed on Apr. 11, 2025, and is incorporated herein by reference in its entirety.

### FIELD OF THE INVENTION

The present invention relates generally to the field of umbrellas. More specifically, the present invention relates to a motorized device that receives an umbrella stand that allows for repositioning of an umbrella via a mobile application or remote repositioning. Accordingly, the present disclosure makes specific reference thereto. Nonetheless, it is to be appreciated that aspects of the present invention are also equally applicable to other like applications, devices, and methods of manufacture.

### BACKGROUND

Traditional outdoor umbrella stands are designed to provide a stable base for umbrellas in environments such as patios, pool areas, and commercial outdoor spaces. However, these stands are often manufactured from dense materials like cast iron, concrete, or water-filled plastic, making them heavy and cumbersome to move. As the position of the sun changes throughout the day, users are required to frequently adjust the location of their umbrellas to maintain shade. This typically necessitates manual repositioning of the umbrella stand, which can involve considerable physical exertion. Such exertion may pose a risk of strain or injury, particularly for older individuals or those with limited mobility. In addition, manually repositioning the stand interrupts activities such as relaxation or social engagement, reducing the overall convenience and enjoyment of outdoor spaces. Furthermore, conventional umbrella stands lack remote control or automated mobility features, limiting user accessibility and adaptability in dynamic environments.

Therefore, there exists a long-felt need in the art for a motorized umbrella stand device that enables convenient repositioning of heavy umbrella stands without physical effort. There also exists a long-felt need in the art for a motorized umbrella stand device that allows users to adjust umbrella orientation remotely without interrupting their activities. Moreover, there exists a long-felt need in the art for a motorized umbrella stand device that reduces the risk of injury associated with manually moving weighted bases.

The subject matter disclosed and claimed herein, in one embodiment thereof, comprises a motorized umbrella stand device. The device is comprised of a body configured to be positioned beneath and that receives a variety of outdoor umbrella stands. The body further comprises multiple wheels for mobility, each of which may include a locking mechanism to prevent unintentional movement. Wheel actuation is enabled through one or more integrated motors powered by a rechargeable battery system, which may be recharged via a charging port or an optional solar panel mounted on an articulation mount. The motor is wirelessly controlled via a remote control and/or a mobile application that includes directional control, braking engagement, and location programming functionality. A GPS module integrated within the device allows for autonomous repositioning based on user-defined locations or solar tracking algorithms.

In this manner, the motorized umbrella stand device of the present invention accomplishes all the forgoing objectives and provides a device that enables powered repositioning of umbrella stands across various surfaces without user exertion. The inclusion of remote and app-based control eliminates the need for users to leave their seated positions, enhancing convenience and usability. The device mitigates the risk of physical strain by replacing manual labor with motor-driven movement, providing a safer alternative for users. Additionally, compatibility with existing umbrella stands and environments such as home patios and commercial pool areas ensures broad applicability and user adoption. As such, the motorized umbrella stand device addresses longstanding challenges associated with traditional umbrella stands by integrating mobility, automation, and user-centric controls into a single functional platform.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized umbrella stand device. The device is designed to reposition umbrella stands without physical effort, particularly in outdoor settings where sunlight direction changes throughout the day. The device is remotely controlled and compatible with various umbrella stands, enhancing convenience and outdoor comfort in residential, commercial, and recreational environments.

The device is comprised of a body configured to be placed beneath umbrella stands. A top surface of the body is comprised of a non-slip interface to minimize lateral movement of the umbrella stand. The body may be further comprised of at least one mechanical fastener configured to secure the umbrella stand to the body.

At least one wheel is included to facilitate movement of the device across various surfaces. Each wheel may include a locking mechanism to inhibit movement. Each wheel may be actuated by a motor capable of enabling omnidirectional or differential movement. The motor receives power from a rechargeable battery having a charging port. The battery may also be recharged using at least one solar panel mounted on the body.

The movement of the wheels may be controlled via a remote control and/or mobile application. The mobile application may allow users to control movement direction, engage wheel locks, and manage destination mapping. A GPS module integrated into the body enables autonomous repositioning to predefined destination points. These points may be programmed manually or generated via solar tracking algorithms, shading optimization, or scheduling routines.

The invention is further comprised of a method for repositioning umbrella stands/umbrellas using the device. The method includes providing the device, placing an umbrella stand with an umbrella on the top surface and securing the stand with optional fasteners, initiating movement via remote or mobile control, engaging wheel locks upon reaching a desired position, and repeating movement as needed. In some embodiments, the GPS module enables autonomous relocation to pre-programmed positions throughout the day.

Accordingly, the motorized umbrella stand device of the present invention is particularly advantageous as it provides a device that enables powered repositioning of umbrella stands across various surfaces without user exertion. The inclusion of remote and app-based control eliminates the need for users to leave their seated positions, enhancing convenience and usability. The device mitigates the risk of physical strain by replacing manual labor with motor-driven movement, providing a safer alternative for users. Additionally, compatibility with existing umbrella stands and environments such as home patios and commercial pool areas ensures broad applicability and user adoption. Therefore, the motorized umbrella stand device addresses longstanding challenges associated with traditional umbrella stands by integrating mobility, automation, and user-centric controls into a single functional platform.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a motorized umbrella stand device of the present invention in accordance with the disclosed architecture;

FIG. 2 illustrates a perspective view of one potential embodiment of a motorized umbrella stand device of the present invention receiving an umbrella stand in accordance with the disclosed architecture;

FIG. 3 illustrates a graphical schematic view of features of a mobile application of one potential embodiment of a motorized umbrella stand device of the present invention in accordance with the disclosed architecture;

FIG. 4 illustrates a flowchart of a method of using one potential embodiment of a motorized umbrella stand device of the present invention in accordance with the disclosed architecture; and

FIG. 5 illustrates a perspective view of one potential embodiment of a motorized umbrella stand device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a motorized umbrella stand device that enables convenient repositioning of heavy umbrella stands without physical effort. There also exists a long-felt need in the art for a motorized umbrella stand device that allows users to adjust umbrella orientation remotely without interrupting their activities. Moreover, there exists a long-felt need in the art for a motorized umbrella stand device that reduces the risk of injury associated with manually moving weighted bases.

The present invention, in one exemplary embodiment, is comprised of a motorized umbrella stand device. The device enables repositioning of umbrella stands without requiring user exertion, making the device particularly useful in outdoor environments where sunlight direction shifts throughout the day. The device can be controlled via remote operation, and the device supports compatibility with a wide range of umbrella stands to improve user convenience and comfort in residential, commercial, and recreational areas.

The structure of the device includes a body designed to be placed beneath umbrella stands. The body features a top surface with a non-slip interface that reduces lateral displacement. Additionally, the body may incorporate at least one mechanical fastener to secure the umbrella stand in place.

To enable movement across diverse surface types, the device includes at least one wheel. Each wheel may integrate a locking mechanism to prevent unintentional movement. Motors further actuate the wheels, wherein power is supplied by a rechargeable battery connected to a charging port, with supplemental recharging available through at least one solar panel mounted on the body.

Wheel actuation may be controlled using either a remote control or a mobile application. Through the mobile application, users may direct movement, activate wheel locks, and access destination mapping features. An integrated GPS module allows for automatic movement of the device to predefined locations. These locations may be set manually or generated by algorithms that track solar position, optimize shading, or follow time-based schedules.

The invention also includes a method for repositioning umbrella stands using the device. The method involves preparing the device, placing the umbrella stand and umbrella onto the non-slip surface, optionally securing the stand using fasteners, initiating movement through the control interface, activating wheel locks once the target location is reached, and repeating the procedure as necessary. In certain implementations, the GPS module enables the device to reposition automatically according to pre-established waypoints throughout the day.

As a result, the motorized umbrella stand device offers a powered solution for repositioning umbrella stands over various surfaces without manual effort. The integration of app-based and remote control improves usability by eliminating the need for user intervention. Physical strain is reduced through motor-driven operation, offering a safer and more accessible alternative. Compatibility with standard umbrella stands and widespread applicability to locations such as residential patios and commercial pool areas further supports adoption. Therefore, the device effectively addresses limitations of conventional umbrella stands by combining mobility, automation, and user-oriented controls into a unified system.

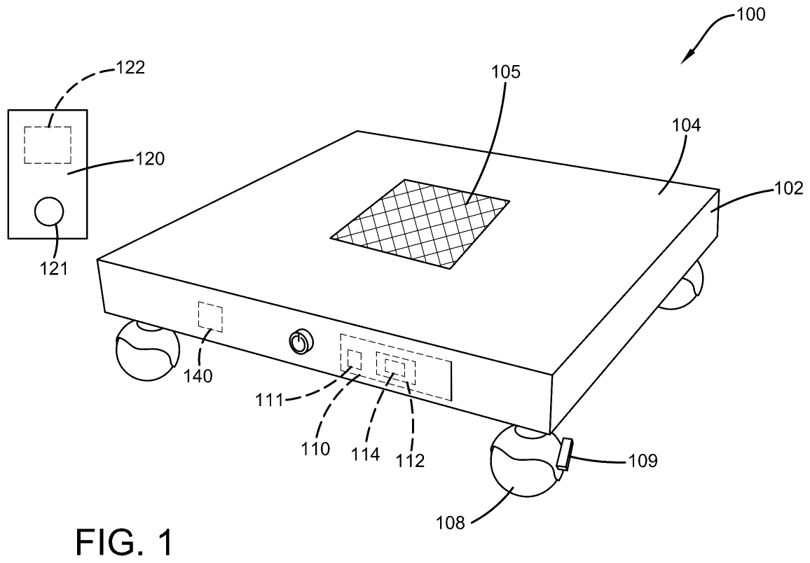

Referring initially to the drawings, FIG. 1 illustrates a perspective view of one potential embodiment of a motorized umbrella stand device 100 of the present invention in accordance with the disclosed architecture. The device 100 can be used for repositioning umbrella stands without requiring physical effort from a user. The device 100 is particularly suited for outdoor environments where the direction of sunlight changes throughout the day, necessitating frequent positioning adjustments to umbrellas. By enabling remote-controlled mobility and offering broad compatibility with existing umbrella stands, the device 100 enhances user convenience and improves outdoor comfort in residential, commercial, and recreational settings.

The device 100 may be comprised of a body 102 configured to be positioned beneath a variety of umbrella stands. The body 102 may be any geometric shape including circular, square, rectangular, polygonal, or custom-shaped to suit specific umbrella stand 10 profiles. The body 102 may be fabricated from materials such as, but not limited to, extruded aluminum, injection-molded high-impact polymer composites, reinforced fiberglass panels, weather-resistant vinyl laminates, etc. In one embodiment, the body 102 may be dimensioned to exceed the outer footprint of a typical umbrella stand base by approximately (but not limited to) one inch on each lateral edge.

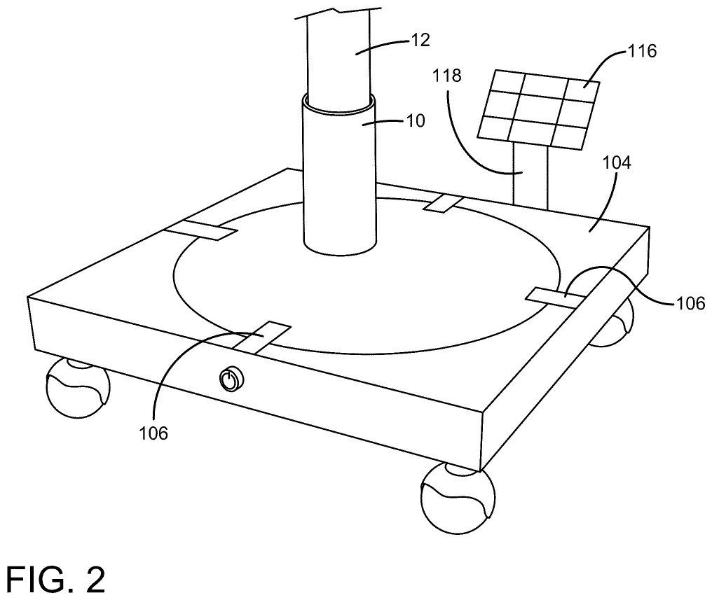

A top surface 104 of the body 102 may be comprised of a non-slip interface configured to minimize lateral displacement of the umbrella base 10, as seen in FIG. 2. The top surface 104 may be comprised of a variety of grip-enhancing features 105, such as but not limited to a textured rubberized overlay, thermoplastic elastomeric matting, grit-embedded polymer coatings, integrated traction ridges, etc.

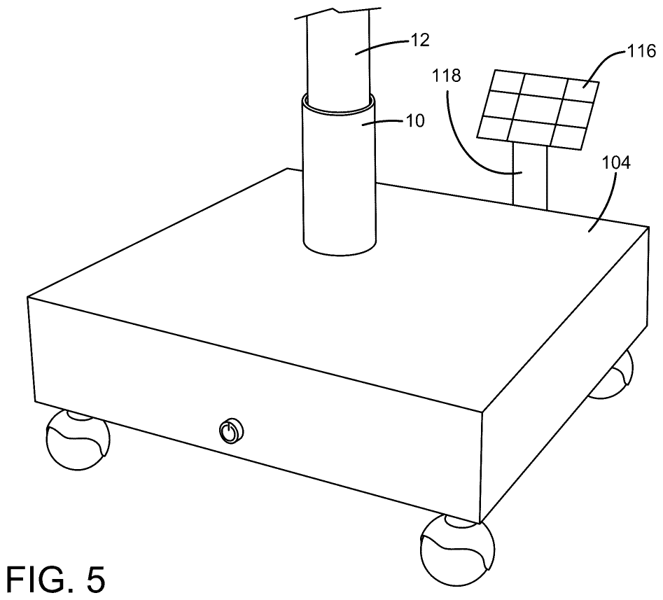

In one embodiment, the body 102 may be further comprised of at least one mechanical fastener 106 configured to secure the umbrella base 10 to the body 102, as seen in FIG. 2. The fastener 106 may include, but is not limited to, elastic retention bands, spring-loaded clips, manual or automatic clamps, adjustable tensioning straps, recessed areas, magnets, locking slots, mechanical detents, vertical anchoring posts, etc. In one embodiment, the base 10 is fixedly attached to the body 102 and/or is integrally formed as part of the body 102, as seen in FIG. 5.

The body 102 may be further comprised of at least one wheel 108 configured to facilitate movement of the device 100 (and attached umbrella) over a range of outdoor and indoor surfaces. The wheel 108 may be but is not limited to omnidirectional caster wheels, pneumatic tires, treaded rubber wheels, or suspension-integrated rollers depending on terrain requirements. Each wheel 108 may be integrated with a locking mechanism 109 configured to inhibit movement of the device 100 once the device 100 is positioned in the desired location. The locking mechanism 109 may be comprised of but is not limited to, mechanical friction brakes, servo-actuated pin locks, magnetic detent locks, solenoid-driven clamps, or electromechanical gear interlocks.

The wheel 108 may be actuated by a motor 110, as seen in FIG. 1. The motor 110 may be comprised of but is not limited to a brushless DC electric drive motor, a stepper motor, or a geared transmission motor, etc. capable of delivering torque to a corresponding wheel 108 to enable omnidirectional or differential drive movement.

The motor 110 may receive electrical energy from a rechargeable battery 112. The battery 112 may be comprised of a lithium-ion, lithium-polymer, or lithium-iron-phosphate (LiFePO4) chemistry. The battery 112 may be connected to a charging port 114 which may include but is not limited to weather-sealed USB-C receptacles, polarized DC barrel jacks, inductive charging pads, or magnetic coupling connectors.

Alternatively or additionally, the battery 112 may be recharged via at least one solar panel 116 mounted on the body 102, as seen in FIG. 2. The solar panel 116 may be comprised of (but is not limited to) high-efficiency monocrystalline or polycrystalline photovoltaic cells. In one embodiment, the solar panel 116 is mounted on an articulation mount 118 such as but not limited to a multi-axis gimbal, a ball-and-socket joint, a telescopic extension arm, a curved track-guided slider, etc. The mount 118 may be either manually adjustable or motor-driven to dynamically orient the solar panel 116 toward incident sunlight.

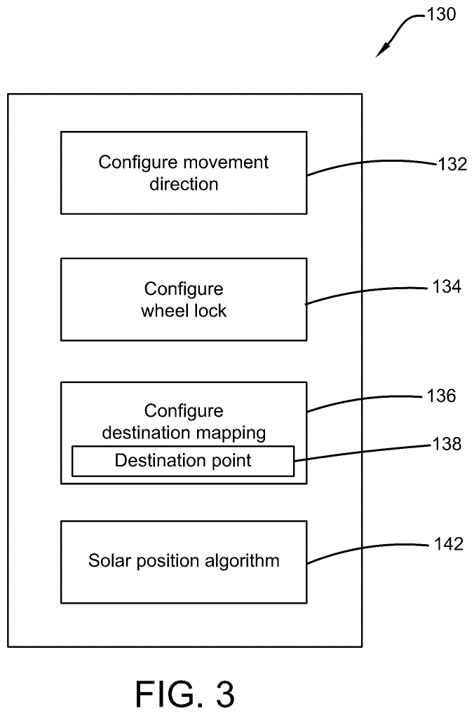

Movement of the wheels 108 may be controlled by at least one remote control 120 (as seen in FIG. 1) and/or at least one mobile application 130 (as seen in FIG. 3). The motor 110 may be comprised of an integrated wireless communication module 111 configured to facilitate bidirectional data exchange between the motor 110 and the remote control 120 or mobile application 130. The wireless communication modules 111, 122 may operate on communication protocols such as, but not limited to, Bluetooth Low Energy (BLE), 2.4 GHz Wi-Fi, sub-GHz RF, Zigbee, or cellular IoT standards.

The mobile application 130 may allow a user to control the movement direction 132 and operational state of the device 100. The application 130 may include user interfaces for directional control of the entire device (132), wheel locking mechanism 109 engagement (134), and destination mapping features (136). Geolocation and memory-based repositioning may be enabled via a GPS module 140 integrated into the body 102, facilitating autonomous relocation to predefined destination points (138). These destination points 138 may be manually programmed via the application 130 or generated through solar position algorithms (142), shading optimization routines, or temporal scheduling. Any feature of the mobile application 130 may be present and controlled via at least one button 121 on the remote 120.

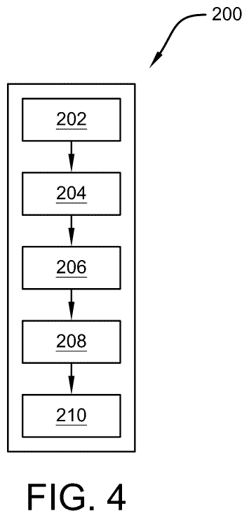

The present invention is also comprised of a method of using 200 the device 100, as seen in FIG. 4. First, a device 100 is provided comprised of a body 102 configured to be positioned beneath an umbrella stand 10, wherein the body 102 includes at least one top surface 104 comprised of a non-slip interface, at least one wheel 108, at least one motor 110, at least one rechargeable battery 112, and at least one remote control 120 and/or mobile application 130 [Step 202]. Then, the umbrella stand 10 with an umbrella 12 can be positioned onto the top surface 104 of the body 102, wherein the top surface 104 may include at least one grip-enhancing feature 105 and the stand 10 can be optionally secured using at least one mechanical fastener 106 [Step 204]. Next, the user can initiate movement of the device 100 by engaging the motor 110 via at least one button 121 on the remote control 120 and/or the mobile application 130, wherein the motor 110 actuates the wheels 108 for controlled repositioning of the umbrella stand 10 [Step 206]. Then, the user can stop the device 100 at a desired location and activate the locking mechanism 109 of each wheel 108 to inhibit further movement [Step 208]. A user can then deactivate the locking mechanism 109 and move the device 100 via the remote control 120 and/or the mobile application 130 to a second location to provide a new position of shade [Step 210]. In one embodiment, the GPS module 140 may be used in conjunction with the mobile application 130 to autonomously reposition the device 100 to predefined destination points 138 throughout the day.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “motorized umbrella stand device” and “device” are interchangeable and refer to the motorized umbrella stand device 100 of the present invention.

Notwithstanding the forgoing, the motorized umbrella stand device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the motorized umbrella stand device 100 as shown in the FIGS. are for illustrative purposes only, and that many other sizes and shapes of the motorized umbrella stand device 100 are well within the scope of the present disclosure. Although the dimensions of the motorized umbrella stand device 100 are important design parameters for user convenience, the motorized umbrella stand device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized umbrella stand device comprising:
a body;
a wheel connected to the body and configured to facilitate 360-degree movement of the body;
a motor configured to actuate the wheel;
a battery configured to supply an electrical energy to the motor; and
a remote control configured to control movement of the wheel.

2. The motorized umbrella stand device of claim 1 further comprising a charging port.

3. The motorized umbrella stand device of claim 1 further comprising a solar panel.

4. The motorized umbrella stand device of claim 1, wherein a top surface of the body is comprised of a grip-enhancing feature.

5. The motorized umbrella stand device of claim 1, wherein the body is comprised of a fastener.

6. The motorized umbrella stand device of claim 5, wherein the fastener is comprised of an elastic retention band, a spring-loaded clip, a manual clamp, an automatic clamp, an adjustable tensioning strap, a recessed area, a magnet, a locking slot, a mechanical detent, or a vertical anchoring post.

7. The motorized umbrella stand device of claim 1, wherein the wheel is comprised of a locking mechanism.

8. The motorized umbrella stand device of claim 7, wherein the locking mechanism is controlled by the motor.

9. The motorized umbrella stand device of claim 1, wherein the remote control is in wireless electrical communication with and controls the motor.

10. A motorized umbrella stand device comprising:
a body;
a wheel connected to the body and configured to facilitate 360-degree movement of the body;
a motor configured to actuate the wheel;
a battery configured to supply an electrical energy to the motor; and
a mobile application configured to control movement of the wheel.

11. The motorized umbrella stand device of claim 10, wherein the wheel is comprised of a locking mechanism.

12. The motorized umbrella stand device of claim 11, wherein the locking mechanism is controlled by the mobile application.

13. The motorized umbrella stand device of claim 10, wherein the mobile application is in wireless electrical communication with and controls the motor.

14. The motorized umbrella stand device of claim 10 further comprised of a solar panel.

15. The motorized umbrella stand device of claim 14, wherein the solar panel attaches to the body via a mount.

16. The motorized umbrella stand device of claim 15, wherein the mounting is comprised of a motor-driven mount that is driven by the motor.

17. The motorized umbrella stand device of claim 10 further comprised of a GPS module.

18. The motorized umbrella stand device of claim 10, wherein the mobile application is configured to control a repositioning of the motorized umbrella stand device via the wheel.

19. A method of using a motorized umbrella stand device, the method comprising the following steps:
providing a motorized umbrella stand device comprised of a body, a wheel, a motor, a battery, and a remote control or a mobile application;
positioning an umbrella stand onto a top surface of the body;
initiating a movement of the motorized umbrella stand device by actuating the motor via the remote control or the mobile application to move the wheel; and
stopping the motorized umbrella stand device at a desired location.

20. The method of using a motorized umbrella stand device of claim 19 further comprised of a step of securing the umbrella stand to the top surface via a fastener.
